(19) United States
(12) Patent Application Publication
(10) Pub. No.: US 2025/0261019 A1
(43) Pub. Date: Aug. 14, 2025

(54) COMMUNICATION METHOD AND COMMUNICATION APPARATUS

(71) Applicant: Beijing Xiaomi Mobile Software Co., Ltd., Beijing (CN)

(72) Inventor: Xiandong DONG, Beijing (CN)

(21) Appl. No.: 18/856,723

(22) PCT Filed: Apr. 15, 2022
(86) PCT No.: PCT/CN2022/087170

§ 371 Date: Oct. 14, 2024

(51) Int. Cl. H04W 24/10; H04W 84/12

(52) U.S. Cl. CPC H04W 24/10; H04W 84/12

(57) ABSTRACT

A communication method includes: determining a first message frame, wherein the first message frame includes a first subfield, wherein the first subfield identifies information of a long training field in a second message frame, wherein the long training field is configured for sensing measurement; and sending the first message frame.

### CROSS REFERENCE TO RELATED APPLICATION

The present application is a U.S. National Stage of International Application No. PCT/CN2022/087170, filed on Apr. 15, 2022, the content of which is incorporated by reference herein in its entirety.

### TECHNICAL FIELD

The present disclosure relates to the field of wireless communications, and more particularly, to a communication method and a communication device.

### BACKGROUND

Wireless Local Area Network (WLAN) has the characteristics of flexibility, mobility and low cost. With the development of communication technology and the growth of user demand, the application research of WLAN is gradually deepening. For example, WLAN sensing is currently being studied, and its main application scenarios are: location discovery in dense environments (home environment and enterprise environment), proximity detection, and presence detection.

### SUMMARY

Various embodiments of the present disclosure provide the following technical solutions:

According to embodiments of the present disclosure, there is provided a communication method. The communication method may include: determining a first message frame, where the first message frame includes a first subfield, where the first subfield identifies information of a long training field in a second message frame, where the long training field is used for sensing measurement; and sending the first message frame.

According to embodiments of the present disclosure, there is provided a communication method. The communication method may include receiving a first message frame, where the first message frame includes a first subfield, where the first subfield identifies information of a long training field in a second message frame, where the long training field is used for sensing measurement; and obtaining the information of the long training field in the second message frame based on the first message frame.

According to embodiments of the present disclosure, there is provided a communication device. The communication device may include a processing module configured to determine a first message frame, where the first message frame includes a first subfield, where the first subfield identifies information of a long training field in a second message frame, where the long training field is used for sensing measurement; and a transceiver module configured to send the first message frame.

According to embodiments of the present disclosure, there is provided a communication device. The communication device may include a transceiver module configured to receive a first message frame, where the first message frame includes a first subfield, where the first subfield identifies information of a long training field in a second message frame, where the long training field is used for sensing measurement; and a processing module configured to obtain the information of the long training field in the second message frame based on the first message frame.

According to embodiments of the present disclosure, there is provided an electronic device. The electronic device includes a memory, a processor, and a computer program stored in the memory and executable on the processor. When the processor executes the computer program, the method described above is implemented.

According to embodiments of the present disclosure, there is provided a computer-readable storage medium. A computer program is stored on the computer-readable storage medium. When the computer program is executed by a processor, the method described above is implemented.

### BRIEF DESCRIPTION OF THE DRAWINGS

FIG. 1 is a block diagram showing an example mode of WLAN sensing according to an example embodiment.

FIG. 2 is a flowchart illustrating a communication method according to an example embodiment.

FIG. 3 is a flow chart illustrating a TB-based sensing mode according to an example embodiment.

FIG. 4 is a flow chart illustrating a Non-TB based sensing mode according to an example embodiment.

FIG. 5 is a flowchart illustrating another communication method according to an example embodiment.

FIG. 6 is a block diagram illustrating a communication device according to an example embodiment.

### DETAILED DESCRIPTION

The following description with reference to the accompanying drawings is provided to help fully understand the various embodiments of the present disclosure as defined by the attached claims and their equivalents. The various embodiments of the present disclosure include various specific details, but these specific details are considered to be examples only. In addition, for the sake of clarity and brevity, the description of well-known technologies, functions and configurations may be omitted.

The terms and words used in this disclosure are not limited to the written meanings, but are only used by the inventors to enable a clear and consistent understanding of the disclosure. Therefore, for those skilled in the art, the description of various embodiments of the present disclosure is provided only for the purpose of illustration, not for the purpose of limitation.

It should be understood that, unless the context clearly indicates otherwise, the singular forms “a”, “an”, “said” and “the” used herein may also include the plural forms. It should be further understood that the term “including” used in the present disclosure refers to the presence of the described features, integers, steps, operations, elements and/or components, but does not exclude the presence or addition of one or more other features, integers, steps, operations, elements, components and/or groups thereof.

It will be understood that although the terms “first”, “second”, etc. may be used herein to describe various elements, these elements should not be limited by these terms. These terms are only used to distinguish one element from another element. Therefore, without departing from the teachings of the example embodiments, the first element discussed below may be referred to as the second element.

It should be understood that when an element is referred to as being “connected” or “coupled” to another element, it may be directly connected or coupled to the other element, or there may be intermediate elements. In addition, “connected” or “coupled” as used herein may include wireless connections or wireless couplings. The term “and/or” or the expression “at least one of . . . ” as used herein includes any and all combinations of one or more of the associated listed items.

Unless otherwise defined, all terms (including technical and scientific terms) used herein have the same meaning as commonly understood by one of ordinary skill in the art to which this disclosure belongs.

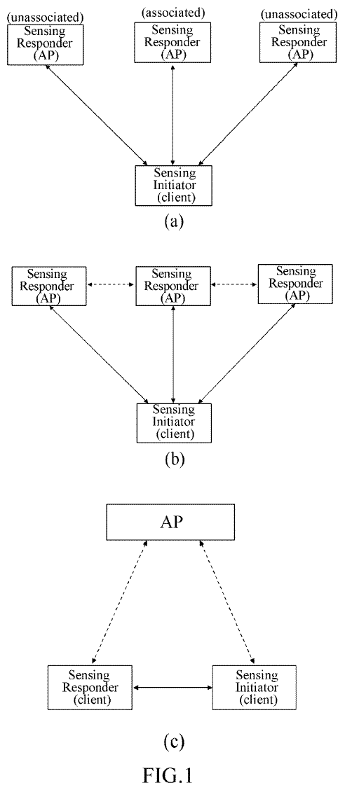

FIG. 1 is a block diagram showing an example mode of WLAN sensing.

The process of WLAN sensing may be: an initiator initiates WLAN sensing (e.g., initiates a WLAN sensing session), and there may be multiple responders responding thereto. Specific possible methods may be shown in (a), (b) and (c) in FIG. 1.

Referring to FIG. 1 (a), when a WLAN sensing initiator (e.g., a client) initiates WLAN sensing, a plurality of associated or unassociated WLAN sensing responders (e.g., three access points (AP)) can respond. Here, “associated” may refer to that an association connection for communication is established between the initiator and the responder, and “non-associated” may refer to that no association connection for communication is established between the initiator and the responder.

By way of example, the client may include, but is not limited to, cellular phones, smart phones, wearable devices, computers, personal digital assistants (PDAs), personal communication system (PCS) devices, personal information managers (PIMs), personal navigation devices (PNDs), global positioning systems, multimedia devices, Internet of Things (IoT) devices, etc.

An AP can be a wireless switch for a wireless network or an access device for a wireless network. An AP can include a software application and/or a circuit to enable other types of nodes in a wireless network to communicate with the outside and inside of the wireless network through the AP. As an example, an AP can be a terminal device or a network device equipped with a Wi-Fi (Wireless Fidelity) chip.

FIG. 1 (b) is similar to FIG. 1 (a), but in FIG. 1 (b), responders (APs) can communicate with each other.

Referring to FIG. 1 (c), both the WLAN sensing initiator and the WLAN sensing responder may be clients, and both may communicate by connecting to the same AP.

Although (a), (b) and (c) in FIG. 1 show that the client is the initiator and the AP is the responder, the present disclosure is not limited thereto. For example, in various embodiments of the present disclosure, the AP may be the initiator and the client may be the responder. In addition, in various embodiments of the present disclosure, the client may also be referred to as a non-AP station (non-AP STA), abbreviated as a “station (STA)”. In addition, the number of initiators and responders is not limited to that shown in (a), (b) and (c) in FIG. 1.

As an illustrative embodiment, the process of WLAN sensing may include: WLAN sensing session establishment, WLAN sensing measurement establishment and WLAN sensing measurement termination. In the WLAN sensing session establishment, an operating parameter associated with the sensing session may be determined and exchanged between devices. In the WLAN sensing measurement establishment, sensing measurement and/or reporting of the measurement result may be performed, so the WLAN sensing measurement establishment may also be referred to as a WLAN sensing measurement process. In the WLAN sensing measurement termination, the device stops performing measurement and terminates the sensing session.

In addition, in the WLAN sensing technology, a trigger-based (TB-base) sensing mode and a non-trigger-based (Non-TB based) sensing mode are proposed. For example, the TB-based sensing mode is based on the form of a Null Data Packet Announcement (NDPA) frame and a trigger frame (trigger), with the AP as the initiator. The Non-TB based sensing mode is based on the form of an NDPA, with the station (STA) as the initiator. In addition, both the TB-based sensing mode and the Non-TB based sensing mode use a Null Data Packet (NDP) frame as a sensing measurement frame to participate in the sensing measurement.

In TB-based scenarios, NDP frames are all sensing measurement frames participating in sensing measurement. In Non-TB based scenarios, in order to maintain protocol completeness, UL NDP frames or DL NDP frames that do not participate in sensing measurement may be sent in uplink sensing measurement (UL sounding) or downlink sensing measurement (DL sounding).

In the current study, the long training field (LTF) in the NDP frame is mainly used for sensing measurement. LTF is also reused for sensing measurement during sensing measurement. However, the TB-based sensing mode and the TB-based sensing mode lack clear provisions on the LTF in the NDP frame at present, so signaling enhancement is needed.

In view of this, a communication method and a communication device are provided according to the concept of an embodiment of the present disclosure.

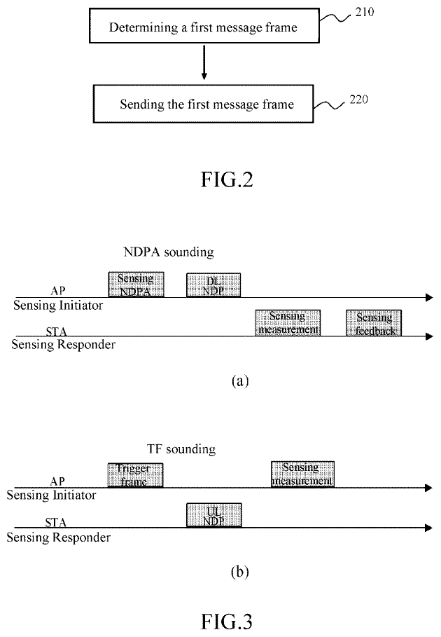

FIG. 2 is a flow chart showing a communication method according to an example embodiment. The communication method shown in FIG. 2 may be applied to an access point (AP) or to a station (abbreviated as: station “STA”) which is not an access point.

Referring to FIG. 2, in step 210, a first message frame is determined, where the first message frame may include a first subfield, where the first subfield identifies information of a long training field (LTF) in a second message frame, where the long training field is used for sensing measurement. In step 220, the first message frame is sent.

In the embodiments of the present disclosure, there are many ways to determine the first message frame. For example, the first message frame can be generated or configured according to at least one of the following conditions: channel state, network condition, load condition, hardware capability of the sending/receiving device, service type, and relevant protocol regulation. The embodiments of the present disclosure are not specifically limited to this. In the embodiments of the present disclosure, the first message frame can also be obtained from an external device, and the embodiments of the present disclosure are not specifically limited to this.

In an embodiment of the present disclosure, the first message frame may be an NDPA frame or a sensing measurement trigger frame (hereinafter also referred to as a “trigger frame”). The second message frame may carry a long training field. For example, in the following, for the convenience of description, an NDP frame is used as an example of the second message frame. However, the present disclosure is not limited thereto, and other frames carrying LTF are also feasible. Tables 1 and 2 below show the formats of two NDP frames as examples only.

TABLE 1
HE sounding NDP frame format

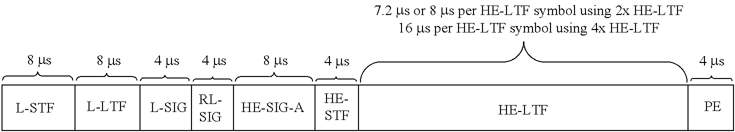

TABLE 2
HE ranging NDP frame format

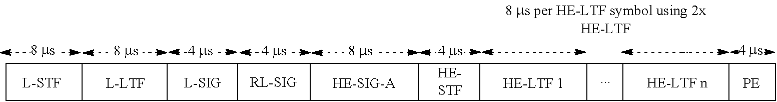

Table 1 shows HE (High Efficiency) sounding NDP frame format, and Table 2 shows HE ranging NDP frame format. “HE-LTF” in Table 1 and “HE-LTF 1” to “HE-LTF n” in Table 2 may refer to the long training field in the second message frame in the above embodiment. In addition, referring to Tables 1 and 2, the NDP frame may also include: a legacy short training field (L-STF), a legacy long training field (L-LTF), a legacy signaling field (L-SIG), a repeated legacy signaling field (RL-SIG), a HE signaling field (HE-SIG-A) and a HE short training field (HE-STF), and a data packet extension field (PE), etc. However, this is only an example and the present disclosure is not limited thereto.

It is to be understood, though available NDP frame formats are indicated in Tables 1 and 2 above, they are only examples and the present disclosure is not limited thereto. For example, EHT (Extreme High-Throughput) sounding NDP frames and the like are also applicable to various example embodiments of the present disclosure.

According to an embodiment of the present disclosure, the first subfield in the first message frame may be a long training field repetition (LTF repetition) subfield, for identifying the number of LTFs in the second message frame. In other words, information (e.g., the number of LTFs) of the LTF (such as “HE-LTF” in Table 1 and “HE-LTF 1” to “HE-LTF n” in Table 2) in the second message frame (NDP frame) may be identified in the first message frame (NDPA frame or sensing measurement trigger frame). The first subfield (i.e., the LTF repetition subfield) can increase the signal-to-noise ratio (SNR), which is very important for sensing measurement applications. In addition, identifying the information (e.g., the number of LTFs) of the LTF in the second message frame in the first message frame in advance is conducive to ensuring the secure reception and correct parsing of signaling during the sensing measurement process, for example, ensuring the security of the LTF, so that consistency check can be performed in channel estimation to detect security attack.

In an embodiment of the present disclosure, the value of the first subfield (i.e., the number of LTFs) may be set/determined based on a sensing mode (TB-based or Non-TB based) or whether the second message frame (NDP frame) participates in sensing measurement.

According to an embodiment of the present disclosure, the first message frame (NDPA frame or sensing measurement trigger frame) may include a second sub-field, where the second sub-field may be used for an identifier that identifies a device to which the first sub-field is to be applied, and the second sub-field may correspond to the first sub-field. For example, the first message frame may include one or more first sub-fields and their respective corresponding second sub-fields, thereby identifying information of the LTF in the second message frame of one or more devices.

For example, in the case where the first subfield is to be applied to a station (STA), the identifier may identify the station (STA). For example, the identifier may be an AID or a UID. The AID may indicate an identifier of a station that has established an associated communication with the AP, and the UID indicates an identifier of a station that has not established an associated communication with the AP. For example, in the case where the first subfield is to be applied to an access point (AP), the identifier may identify the access point (AP). For example, the identifier may be a special AID, for example but not limited to, using a special AID with a value of 0 to identify the AP.

In addition, in an optional embodiment, the first message frame (NDPA frame or sensing measurement trigger frame) may include a station information (STA info) field, and the first subfield and the second subfield may be included in the station information field. For example, the station information field may include LTF repetition subfield, which identifies the number of LTFs contained in the NDP frame in the sensing measurement. In addition, the LTF repetition subfield may correspond to the STA identifier, where the identifier may be AID (establishing association) or UID (not establishing association). For example, in the Non-TB based sensing measurement, the corresponding station information field may be used for AP, and the AID may be a special AID, such as 0.

The communication method according to the embodiment of the present disclosure improves the definition of the number of LTFs in the sensing measurement process to adapt it to the need of WLAN sensing measurement.

FIG. 3 is a flow chart illustrating a TB-based sensing mode according to an example embodiment.

According to an embodiment of the present disclosure, in a trigger-based sensing measurement process (i.e., in a TB-based sensing mode), a second message frame (e.g., an NDP frame) may participate in the sensing measurement and a first message frame (e.g., an NDPA frame or a sensing measurement trigger frame) may identify that the number of LTFs in the second message frame is at least 1.

In the TB-based sensing mode, the WLAN sensing measurement process may include three steps: polling, measurement, and feedback. In the polling step, the initiator (AP) may send a poll frame to check the availability of the responder (one or more STAs). If the STAs are available, they may report a response frame (e.g., CTS-to-self). In the measurement step, the NDPA sounding mode (hereinafter referred to as “NDPA sounding”) and/or the TF (trigger frame) sounding mode (hereinafter referred to as “TF sounding”) may be used. In the feedback step, the sensing measurement result, such as channel state information (CSI), may be fed back. FIG. 3 (a) shows a flow chart of NDPA sounding, and FIG. 3 (b) shows a flow chart of TF sounding.

Referring to (a) of FIG. 3, in the case of NDPA sounding, the initiator (AP) may send an NDPA frame and an NDP frame to the responder (STA), where the NDPA frame may correspond to the first message frame in the above embodiment, and the NDP frame may correspond to the second message frame in the above embodiment. The NDPA frame may identify the number of LTFs in the NDP frame. The responder (STA) may receive the NDPA frame and the NDP frame, and perform WLAN sensing measurement using the NDP frame, and then report the sensing measurement result (e.g., CSI) to the initiator (AP). For example, the responder (STA) may parse the NDPA frame to learn the number of LTFs in the identified NDP frame, and may parse the NDP frame to check whether the number of LTFs in the received NDP frame is the same as the number identified in the NDPA frame. Here, the NDP frame may participate in the sensing measurement, and therefore, the number identified in the NDPA frame may be set to at least 1.

In an optional embodiment, in (a) of FIG. 3, the NDPA frame may further include an identifier (e.g., a special AID) of the initiator (AP) to identify that the number of LTFs identified in the NDPA frame is applied to the AP (e.g., applied to the NDP frame sent by the AP).

Referring to (b) of FIG. 3, in the case of TF sounding, the initiator (AP) may send a trigger frame (i.e., a sensing measurement trigger frame) to the responder (STA), and then the responder (STA) may send an NDP frame to the initiator (AP), so that the initiator (AP) may use the NDP frame to perform WLAN sensing measurement. The trigger frame (i.e., the sensing measurement trigger frame) may correspond to the first message frame in the above embodiment, and the NDP frame may correspond to the second message frame in the above embodiment. The trigger frame (i.e., the sensing measurement trigger frame) may identify the number of LTFs in the NDP frame. The responder (STA) may parse the trigger frame (i.e., the sensing measurement trigger frame) to learn the number of LTFs in the identified NDP frame, and may include the identified number of LTFs in the NDP frame. The initiator (AP) may check whether the number of LTFs in the NDP frame is the same as the number identified by the first subfield of the NDPA frame when receiving the NDP frame. Here, the NDP frame may participate in the sensing measurement, and thus the number identified in the NDPA frame may be set to at least 1.

In an optional embodiment, in (b) of FIG. 3, the trigger frame (i.e., the sensing measurement trigger frame) may also include an identifier (AID or UID) of the responder (STA) to identify that the number of LTFs identified in the NDPA frame is applied to the STA (e.g., applied to the NDP frame sent by the STA).

Though only one responder (STA) is shown in (a) and (b) of FIG. 3, the present disclosure is not limited thereto, and there may be one or more responders (STA). In this case, for each of the one or more responders (STA), in the NDPA frame or the trigger frame, the number of LTFs in the NDP frame and the identifier of the device to which the identified number of LTFs is applied are respectively identified.

For example, in the TB-based sensing measurement process described with reference to (a) and (b) of FIG. 3, at least one station information field may be included in either the NDPA frame or the trigger frame, where the station information field may include LTF repetition subfield, the number of which can be set to at least 1 to identify the number of LTFs in the NDP frame subsequently participating in the sensing measurement.

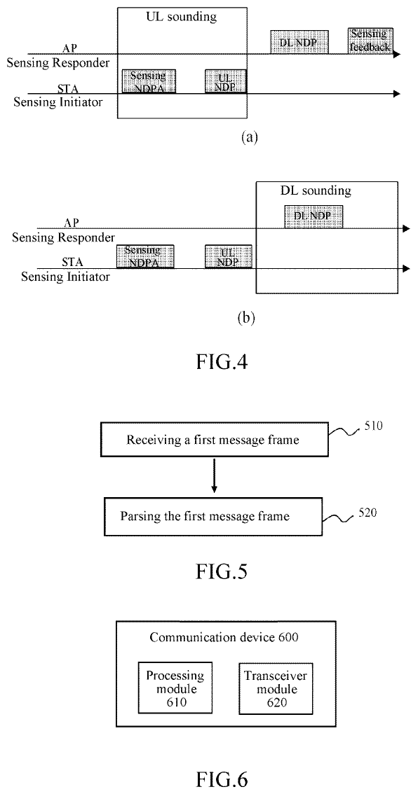

FIG. 4 is a flow chart illustrating a Non-TB based sensing mode according to an example embodiment.

According to an embodiment of the present disclosure, in a non-trigger-based sensing measurement process (i.e., in a Non-TB based sensing mode), in a case where a second message frame (e.g., NDP frame) participates in the sensing measurement, a first message frame (e.g., NDPA frame) may identify that the number of LTFs in the second message frame is at least 1. In a case where the second message frame (e.g., NDP frame) does not participate in the sensing measurement, a first subfield (e.g., NDPA frame) may identify that the number of LTFs in the second message frame is 1. However, the present disclosure is not limited thereto, and the number of LTFs identified in the first message frame may be set to different values depending on whether the second message frame participates in the sensing measurement. For example, the number of LTFs identified in a case of participating in the sensing measurement may be set to be greater than the number of LTFs identified in a case of not participating in the reference measurement.

In the Non-TB based sensing mode, the station (STA) sends an NDPA frame to the AP for a sensing measurement process. For example, in the Non-TB based sensing mode, the WLAN sensing measurement process may include uplink sensing measurement (also referred to as “UL sounding”) or downlink sensing measurement (also referred to as “DL sounding”), or both. FIG. 4 (a) shows a flowchart of uplink sounding, and FIG. 4 (b) shows a flowchart of downlink sounding.

Referring to (a) of FIG. 4, uplink sounding may include: the initiator (STA) sends an NDPA frame and an NDP frame (shown as “UL NDP”) to the responder (AP), and the AP performs WLAN sensing measurement using the UL NDP. In addition, after receiving the NDP frame from the STA, the AP also sends an NDP frame (shown as “DL NDP”), but the NDP frame (DL NDP frame) is not used for WLAN sensing measurement, but only to identify that it has received the NDPA frame and the NDP frame from the STA. Here, the NDPA frame may correspond to the first message frame in the above embodiment, and the UL NDP and DL NDP may correspond to the second message frame in the above embodiment. In uplink sounding, the UL NDP sent by the initiator (STA) participates in the sensing measurement, and thus for the initiator (STA), the number of LTFs identified in the NDPA frame can be set to at least 1. However, the DL NDP sent by the responder (AP) does not participate in the sensing measurement, and thus for the responder (AP), the number of LTFs identified in the NDPA frame can be set to 1.

In an optional embodiment, in (a) of FIG. 4, the NDPA frame may include a station information field about the STA and a station information field about the AP. The station information field about the STA may include: the number of LTFs in the UL NDP and an identifier of the STA (e.g., AID or UID). The station information field about the AP may include: the number of LTFs in the DL NDP and an identifier of the AP (e.g., a special AID).

Referring to (b) of FIG. 4, the downlink sounding may include: the initiator (STA) sends an NDPA frame and an NDP frame (shown as “UL NDP”) to the responder (AP), and the AP sends an NDP frame (shown as “DL NDP”) to the STA, so that the STA uses the received NDP frame to perform WLAN sensing measurement, but the NDP frame (UL NDP) sent by the STA is not used for WLAN sensing measurement, but is only for the purpose of protocol integrity. Here, the NDPA frame may correspond to the first message frame in the above embodiment, and the UL NDP and DL NDP may correspond to the second message frame in the above embodiment. In downlink sounding, the UL NDP sent by the initiator (STA) does not participate in the sensing measurement, so the number of LTFs identified in the NDPA frame may be set to 1 for the initiator (STA). However, the DL NDP sent by the responder (AP) participates in the sensing measurement, so the number of LTFs identified in the NDPA frame may be set to at least 1 for the responder (AP).

In an optional embodiment, the NDPA frame may include a station information field about the STA and a station information field about the AP. The station information field about the STA may include: the number of LTFs in the UL NDP and an identifier of the STA (for example, AID or UID). The station information field about the AP may include: information on the number of LTFs in the DL NDP and an identifier of the AP (for example, a special AID).

For example, in the Non-TB based sensing process referring to (a) and (b) of FIG. 4, if the NDP frame participates in the sensing measurement, the number identified by the LTF repetition subfield in the station information field of the NDPA frame can be set to at least 1. If the NDP frame does not participate in the sensing measurement, the number identified by the LTF repetition subfield in the station information field of the NDPA frame can be set to 1.

According to an embodiment of the present disclosure, the number of LTFs in an NDP frame (e.g., LTF repetition subfield) can be included in the NDPA frame (Non-TB based or TB-based) or the sensing measurement trigger frame (TB-based), so that the sensing measurement resource can be allocated to the STA or AP participating in the measurement, instead of being included in the polling frame or the sensing measurement report frame. In this way, the number of LTFs in the subsequently transmitted NDP frame can be clearly identified in the NDPA frame or the sensing measurement trigger frame, which helps the safe reception and correct parsing of the signaling.

The communication method according to the embodiment of the present disclosure improves the definition of the number of LTFs under the Non-TB based sensing mode and the TB-based sensing mode and adapt it to the need of WLAN sensing measurement.

FIG. 5 is a flow chart showing another communication method according to an example embodiment. The communication method shown in FIG. 5 can be applied to an access point (AP) or a station (abbreviated as: station “STA”) which is not an access point.

Referring to FIG. 5, in step 510, a first message frame can be received, where the first message frame can include a first subfield, where the first subfield identifies information of a long training field in a second message frame. The long training field is used for sensing measurement. In step 520, the first message frame can be parsed, and more specifically, information of the long training field in the second message frame can be obtained based on the first message frame.

According to an embodiment of the present disclosure, the first message frame may be an NDPA frame or a sensing measurement trigger frame.

According to an embodiment of the present disclosure, the second message frame may be an NDP frame.

According to an embodiment of the present disclosure, the first subfield may be a long training field repetition subfield, for identifying the number of long training fields in the second message frame.

According to an embodiment of the present disclosure, the first message frame may include a second subfield, where the second subfield identifies an identifier of a device to which the first subfield is to be applied, where the second subfield corresponds to the first subfield.

According to an embodiment of the present disclosure, in a trigger-based sensing measurement process, the second message frame may participate in the sensing measurement and the number identified by the first subfield may be set to at least 1.

According to an embodiment of the present disclosure, in a non-trigger-based sensing measurement process, in a case where the second message frame participates in the sensing measurement, the number identified by the first subfield can be set to at least 1: in a case where the second message frame does not participate in the sensing measurement, the number identified by the first subfield can be set to 1.

The descriptions about the first message frame, the second message frame, the NDPA frame, the sensing measurement trigger frame, the first sub-field, the second sub-field, etc. may be similar to the descriptions in the various embodiments above, and for the sake of brevity, repeated descriptions are omitted here.

FIG. 6 is a block diagram showing a communication device according to an example embodiment. The communication device 600 of FIG. 6 may include a processing module 610 and a transceiver module 620.

The communication device 600 shown in FIG. 6 can be applied to a device (AP or STA) that sends a first message frame. In this case, the processing module 610 can be configured to: determine the first message frame, where the first message frame can include a first subfield, where the first subfield identifies information of a long training field in a second message frame. The long training field is used for sensing measurement. The transceiver module 620 can be configured to: send the first message frame. That is, the communication device 600 shown in FIG. 6 can perform the communication method described with reference to FIG. 2 and the operations performed by the device that sends the NDPA frame or the trigger frame in FIG. 3 and FIG. 4, and the embodiments described with reference to Tables 1 and 2 can be applied here. In order to avoid redundancy, repeated descriptions are omitted here.

In the case where the communication device 600 shown in FIG. 6 can be applied to receiving a first message frame, the transceiver module 620 can be configured to: receive the first message frame, where the first message frame includes a first subfield, where the first subfield identifies information of a long training field in a second message frame. The long training field is used for sensing measurement. The processing module 610 can be configured to: obtain information of a long training field in a second message frame based on the first message frame. That is, the communication device 600 shown in FIG. 6 can perform the communication method described with reference to FIG. 5 and the operations performed by the device that receives the NDPA frame or the trigger frame in FIG. 3 and FIG. 4, and the embodiments described with reference to Tables 1 and 2 can be applied here, and in order to avoid redundancy, repeated descriptions are omitted here.

It will be understood that the communication device 600 shown in FIG. 6 is merely an example, and the embodiments of the present disclosure are not limited thereto. For example, the communication device 600 may further include other modules, such as a memory module, etc. In addition, the various modules in the communication device 600 may be combined into a more complex module, or may be divided into more separate modules.

The communication method and the communication device according to the embodiments of the present disclosure improve the definition of the number of LTFs in the sensing measurement process to adapt it to the need of WLAN sensing measurement.

Based on the same principle as the method provided by the embodiments of the present disclosure, the embodiments of the present disclosure also provide an electronic device, which includes a processor and a memory: wherein the memory stores machine-readable instructions (also referred to as “computer programs”): the processor is configured to execute the machine-readable instructions to implement the method described with reference to FIGS. 2 to 5.

An embodiment of the present disclosure further provides a computer-readable storage medium having a computer program stored thereon. When the computer program is executed by a processor, the method described with reference to FIGS. 2 to 5 is implemented.

In an example embodiment, the processor may be logic boxes, modules, and circuits for implementing or executing various example embodiments described in conjunction with the present disclosure, such as a CPU (Central Processing Unit), a general-purpose processor, a DSP (Digital Signal Processor), ASIC (Application Specific Integrated Circuit), FPGA (Field Programmable Gate Array) or other programmable logic devices, transistor logic devices, hardware components, or any combination thereof. A processor may also be a combination that implements a computing function, such as a combination containing one or more microprocessors, a combination of a DSP and a microprocessor, and the like.

In an example embodiment, the memory may be, for example, a ROM (Read Only Memory), a RAM (Random Access Memory), an EEPROM (Electrically Erasable Programmable Read Only Memory), a CD-ROM (Compact Disc Read Only Memory), or other optical disk storage, optical disc storage (including compact disc, laser disc, optical disc, digital versatile disc, Blu-ray disc, etc.), magnetic disk storage media or other magnetic storage devices, or any other medium that can be configured to carry or store program code in the form of instructions or data structures and can be accessed by a computer, but is not limited to these.

It should be understood that, although the steps in the flowchart of the accompanying drawings are displayed in sequence as indicated by the arrows, these steps are not necessarily executed in sequence in the order indicated by the arrows. Unless otherwise specified herein, there is no strict order restriction on the execution of these steps, and they can be executed in other orders. In addition, at least a portion of the steps in the flowchart of the accompanying drawings may include multiple sub-steps or multiple stages, and these sub-steps or stages are not necessarily executed at the same time, but can be executed at different time, and their execution order is not necessarily sequential, but can be executed in turn or alternately with other steps or at least a portion of the sub-steps or stages of other steps.

Although the present disclosure has been shown and described with reference to certain embodiments of the present disclosure, it will be appreciated by those skilled in the art that various changes may be made in form and detail without departing from the scope of the present disclosure. Therefore, the scope of the present disclosure should not be limited to the embodiments, but should be limited by the appended claims and their equivalents.

1. A communication method, comprising:
determining a first message frame, wherein the first message frame comprises a first subfield, wherein the first subfield identifies information of a long training field in a second message frame, wherein the long training field is configured for sensing measurement; and
sending the first message frame.

2. The communication method according to claim 1, wherein the first subfield is a long training field repetition subfield for identifying a number of long training fields in the second message frame.

3. The communication method according to claim 1, wherein the first message frame comprises a second subfield, wherein the second subfield identifies an identifier of a device to which the first subfield is to be applied, and wherein the second subfield corresponds to the first subfield.

4. The communication method according to claim 2, wherein in a trigger-based sensing measurement process, the second message frame participates in the sensing measurement and the number identified by the first subfield is set to at least 1.

5. The communication method according to claim 2, wherein in a non-trigger-based sensing measurement process, in response to the second message frame participating in the sensing measurement, the number identified by the first subfield is set to at least 1; in response to the second message frame not participating in the sensing measurement, the number identified by the first subfield is set to 1.

6. The communication method according to claim 1, wherein the first message frame is a Null Data Packet Announcement (NDPA) frame or a sensing measurement trigger frame.

7. A communication method, comprising:
receiving a first message frame, wherein the first message frame comprises a first subfield, wherein the first subfield identifies information of a long training field in a second message frame, wherein the long training field is configured for sensing measurement; and
obtaining the information of the long training field in the second message frame based on the first message frame.

8. The communication method according to claim 7, wherein the first subfield is a long training field repetition subfield for identifying a number of long training fields in the second message frame.

9. The communication method according to claim 7, wherein the first message frame comprises a second subfield, wherein the second subfield identifies an identifier of a device to which the first subfield is to be applied, wherein the second subfield corresponds to the first subfield.

10. The communication method according to claim 8, wherein in a trigger-based sensing measurement process, the second message frame participates in the sensing measurement and the number identified by the first subfield is set to at least 1.

11. The communication method according to claim 8, wherein in a non-trigger-based sensing measurement process, in response to the second message frame participating in the sensing measurement, the number identified by the first subfield is set to at least 1; in response to the second message frame not participating in the sensing measurement, the number identified by the first subfield is set to 1.

12. The communication method according to claim 7, wherein the first message frame is a Null Data Packet Declaration (NDPA) frame or a sensing measurement trigger frame.

13. (canceled)

14. (canceled)

15. An electronic device, comprising:
a processor; and
a memory storing a computer program executable by the processor,
wherein the processor is configured to:
determine a first message frame, wherein the first message frame comprises a first subfield, wherein the first subfield identifies information of a long training field in a second message frame, wherein the long training field is configured for sensing measurement; and
send the first message frame.

16. A non-transitory computer-readable storage medium storing a computer program that, when executed by a processor, causes the processor to perform the communication method according to claim 1.

17. The electronic device according to claim 15, wherein the first subfield is a long training field repetition subfield for identifying a number of long training fields in the second message frame.

18. The electronic device according to claim 15, wherein the first message frame comprises a second subfield, wherein the second subfield identifies an identifier of a device to which the first subfield is to be applied, and wherein the second subfield corresponds to the first subfield.

19. The electronic device according to claim 17, wherein in a trigger-based sensing measurement process, the second message frame participates in the sensing measurement and the number identified by the first subfield is set to at least 1.

20. The electronic device according to claim 17, wherein in a non-trigger-based sensing measurement process, in response to the second message frame participating in the sensing measurement, the number identified by the first subfield is set to at least 1; in response to the second message frame not participating in the sensing measurement, the number identified by the first subfield is set to 1.

21. The electronic device according to claim 15, wherein the first message frame is a Null Data Packet Announcement (NDPA) frame or a sensing measurement trigger frame.

22. An electronic device, comprising:
a processor; and
a memory storing a computer program executable by the processor,
wherein the processor is configured to perform the communication method according to claim 7.
